(19) United States
(12) Patent Application Publication
(10) Pub. No.: US 2014/0094212 A1
(43) Pub. Date: Apr. 3, 2014

(54) METHOD OF DEVICE TO DEVICE DISCOVERY AND APPARATUS THEREOF

(71) Applicant: Electronics and Telecommunications Research Institute, Daejeon (KR)

(72) Inventors: Jae Young AHN, Daejeon (KR); Seung Kwon BAEK, Daejeon (KR)

(73) Assignee: Electronics and Telecommunications Research Institute, Daejeon (KR)

(21) Appl. No.: 14/040,007

(22) Filed: Sep. 27, 2013

(30) Foreign Application Priority Data
Sep. 28, 2012 (KR) 10-2012-0109452
Sep. 27, 2013 (KR) 10-2013-0115687

(51) Int. Cl. H04W 48/16; H04W 4/00

(52) U.S. Cl. CPC H04W 48/16; H04W 4/005
USPC 455/517

(57) ABSTRACT

There are provided a method of a device-to-device (D2D) discovery and an apparatus thereof. The method of the device-to-device discovery performed in a terminal may includes registering a discovery service of the terminal using service information on a service provided from an user; transmitting a discovery transmission activation request to a network in which the terminal is located; receiving a response in response to the discovery transmission activation request from the network; and transmitting a discovery message when the response is an approval message.

### CLAIM FOR PRIORITY

This application claims priority to and the benefit of Korean Patent Applications No. 10-2012-0109452 filed on Sep. 28, 2012 and No. 10-2013-0115687 filed on Sep. 27, 2013 in the Korean Intellectual Property Office (KIPO), the entire contents of which are hereby incorporated by reference.

### BACKGROUND

1. Technical Field

Example embodiments of the present invention relate in general to a discovery technology for device-to-device (D2D) communication, and more specifically, to a method and an apparatus to perform discovery between adjacent devices efficiently.

2. Related Art

In a cellular communication environment, a general method for terminals to exchange data each other is a communication via a base station. That is, if a first terminal has data to be transmitted to a second terminal, the first terminal transmits the data to a first base station to which the first terminal is attached at first. Then, the first base station transmits the data received from the first terminal to a second base station to which the second terminal is attached via a core network (CN). At last, the second base station transmits the data received from the first base station to the second terminal. Here, the first base station and the second base station may be the same base station or different base stations.

On the other hand, a device-to-device (D2D) communication may represent a direct communication between terminals without a base station. That is, the first terminal can transmit the data to the second terminal directly without using the base station(s) for the above-mentioned instance.

Also, a device-to-device discovery may represent discovering adjacent terminal or service using a device-to-device link between adjacent terminals for the D2D communication.

### SUMMARY

Accordingly, example embodiments of the present invention are provided to substantially obviate one or more problems due to limitations and disadvantages of the related art. Especially, the method of discovering adjacent devices or services is needed for providing various mobile services, such as a local advertisement targeting to potential customers, finding a taxi with vacant seats, a mobile game with adjacent garners and finding vacant parking lots, without a help of GPS or intervening user.

An example embodiment of the present invention provides a method of using spectrum and a structure of system for a device-to-device discovery.

Another example embodiment of the present invention provides a method of generating a discovery message of a terminal and transmitting the same for a device-to-device discovery.

Another example embodiment of the present invention provides a method of receiving a discovery message and processing the same for a device-to-device discovery.

Another example embodiment of the present invention provides a method of configuring a discovery message of a terminal for a device-to-device discovery.

In an example embodiment, a method of device-to-device discovery performed in a terminal may comprise registering a discovery service of the terminal using service information on a service provided by an user; transmitting a discovery transmission activation request to a network in which the terminal is located; receiving a response in response to the discovery transmission activation request from the network; and transmitting a discovery message when the response is an approval message.

Here, the service information may include information on an URL of a server which provides information on service category and detail information on the service provided.

Also, the information on a service category may be registered using a service code which corresponds to the service category based on a predetermined code mapping scheme.

Here, the discovery transmission activation request may include a discovery type, a discovery state, and a discovery range class.

Here, the response may include information on radio resources allocated for transmission of the discovery message.

Also, the discovery message may be transmitted using the radio resources indicated by the response.

Here, the discovery message may include the service code corresponding to the service category, a discovery identifier corresponding to the terminal.

In another example embodiment, A method of device-to-device discovery performed in a terminal may comprise being inputted service information on a service desired to be provided through the terminal; transmitting a discovery reception activation request to a network in which the terminal is located; receiving a response in response to the discovery reception activation request from the network; and searching a discovery message from a counterpart terminal when the response is an approval message.

Here, the service information may include information on a service category of the service and information on keywords of the service.

Also, the information on a service category may be registered using a service code which corresponds to the service category based on a predetermined code mapping scheme.

Here, the discovery reception activation request may include a discovery type and a discovery state.

Here, the response may include information on radio resources allocated for reception of the discovery message.

Also, the discovery message may be searched and received on the radio resources indicated by the response.

Here, the discovery message includes a service code of a service provided by the counterpart terminal and a discovery identifier corresponding to the counterpart terminal which transmitted the discovery message.

Also, the method may further include determining whether the service code included in the discovery message is the same with the service code indicated by the service information or not; and requesting additional information related to the service provided by the counterpart terminal when the service code included in the discovery message is the same with the service code indicated by the information on a service.

Also, the additional information may include an identifier of the counterpart terminal transmitting the discovery message and an address of a server providing detail information related to the service provided by the counterpart terminal.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to depict a shared type spectrum usage model;

FIG. 2 is a conceptual diagram to depict a dedicated-type spectrum usage model;

FIG. 3 is a conceptual diagram to depict a functional structure for D2D discovery;

FIG. 4 is a block diagram to depict a structure of cellular network for D2D discovery;

FIG. 5 is a conceptual diagram to show an example embodiment of a functional structure of terminals for D2D discovery;

FIG. 6 is a conceptual diagram to depict channel mapping of uplink channels defined for D2D discovery;

FIG. 7 is a sequence chart to show an open-type discovery transmission activation procedure of discoverable UE;

FIG. 8 is a sequence chart to show a discovery channel allocation procedure of discoverable UE;

FIG. 9 is a conceptual diagram to show a discovery service procedure of discovery UE;

FIG. 10 is a conceptual diagram to show a filtering procedure of the discovery service procedure of discovery UE;

FIG. 11 is a sequence chart to depict a discovery configuration information exchange procedure between DMEs;

FIG. 12 is a view to depict an example embodiment of service category information configuration;

FIG. 13 is a view to depict an example embodiment of D2D discovery message configuration;

FIG. 14 is a view to depict another example embodiment of D2D discovery message configuration;

FIG. 15 is a sequence chart to depict a procedure of open-type discovery transmission activation using a control plane;

FIG. 16 is a sequence chart to depict a procedure of open-type discovery service using a control plane;

FIG. 17 is a sequence chart to depict a procedure of open-type discovery transmission activation using an user plane;

FIG. 18 is a sequence chart to depict a procedure of open-type discovery service using an user plane;

FIG. 19 is a sequence chart to depict a procedure of open-type discovery transmission activation using a control plane and a data plane; and

FIG. 20 is a sequence chart to depict a procedure of discovery service using a control plane and a data plane.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Also, the term “network” used in this specification may include a mobile internet such as a Wireless Fidelity (WIFI), a Wireless Broadband Internet (WiBro), and a World Interoperability for Microwave Access (WiMax). Also, it may include 2G cellular network such as a Global System for Mobile communication (GSM) and a Code Division Multiple Access (CDMA), 3G cellular network such as a Wideband Code Division Multiple Access (WCDMA) and a CDMA2000. Also, it may include 3.5G cellular network such as a High Speed Downlink Packet Access (HSDPA) and a High Speed Uplink Packet Access (HSUPA). Also, it may include 4G or beyond 4G cellular network such as a Long Term Evolution (LTE) and a LTE-Advanced.

Hereinafter, embodiments of the present invention will be described in detail with reference to the appended drawings. In the following description, for easy understanding, like numbers refer to like elements throughout the description of the figures, and the same elements will not be described further.

A device-to-device (D2D) discovery is a procedure for a specific user equipment (UE) to discover neighbor user equipments or services based on signal received using radio resources. For this, the user equipments/services desiring to be discovered by neighbor user equipments/services may transmit a predetermined discovery message by using radio resources configured for D2D discovery, and the user equipments/services desiring to discover neighbor user equipments/services may receive the discovery message transmitted using the radio resources configured for D2D discovery.

A range of D2D discovery may be generally classified into a service-level discovery and a device-level discovery. The service-level discovery may mean discovery on services provided by neighbor user equipments, and the device-level discovery may mean discovery on identifiers (IDs) of neighbor user equipments. The D2D discovery which will be considered in the present invention covers two types of discoveries, the service-level discovery and the device-level discovery.

In the specification, a terminal desiring to be discovered by neighbor terminals may be defined as ‘a discoverable UE’ and a terminal desiring to discover neighbor terminals may be defined as ‘a discovery UE’.

On the other hand, an ‘open-type discovery’ may mean a discovery that a terminal discovers neighbor terminal providing a specific service in order to be provided with the specific service, and it does not need a reciprocal approval for service provisioning. For this, a discoverable UE may register to an open-type discovery transmission service, generate an open-type discovery message according to related procedures, and transmit the generated open-type discovery message.

A discovery UE may receive the open-type discovery message transmitted from the discoverable UE, filter information meeting service requirements of an application only from the received open-type discovery message, obtain additional information via supports of network based on the filtered information, and deliver the obtained additional information to the application. The application may obtain further detail information from the discoverable UE and/or a related server by using the additional information. Here, the application may be located in the discovery UE.

The application may instantly provide the detail information to the user, or provide the detail information to the user only when the application determines the detail information obtained is related to information which the application demands. Also, the discovery UE may perform procedures of reporting the information obtained through the above-described discovery procedure and reporting discovery events, for performing the procedures of reporting, an interoperation procedure between discovery management entities (DMEs) may be performed, wherein the discovery UEs and the discoverable UEs are managed by different discovery management entities.

A discoverable UE in the open-type discovery may be classified into a mobile-type UE or a fixed-type UE. The examples are shown as follows.
Fixed-type: above mid-grade neighbor restaurants with customer reputations over grade 4, for which customers can use discount coupons or cash back services.
Fixed-type of semi-fixed type: near stores which sell specific products which the user wants to buy.
Fixed type: near vacant parking lots.
Mobile-type: near vegetable or fishery seller going around with a vehicle.
Mobile-type: near parcel collector (for courier services such as DHL and FeDex)
Mobile-type: near taxi with vacant seats
Mobile-type: near gamers who desire to play a multi-player game with the user

A spectrum usage model for the D2D discovery and D2D communication may be classified into shared-type model and dedicated-type model. In the shared-type, the D2D discovery and communication are performed in the spectrum which is the same with cellular spectrum. On the contrary, in the dedicated-type model, the D2D discovery and the communication are performed in spectrum dedicated for the D2D discovery shared by a plurality of mobile network operators.

FIG. 1 is a conceptual diagram to depict a shared-type spectrum usage model.

Referring to FIG. 1, terminals may perform the D2D discovery using a portion of cellular spectrum allocated to the respective mobile communication operator network. That is, the terminal may perform the D2D discovery and communication by using the same carrier frequency with that of cellular communication or using carrier frequency separated from that of the cellular communication.

A control/configuration, an authentication, and a charging for the D2D discovery may performed via cellular network of operator which the terminal subscribes to.

In the shared-type usage model, the terminal can receive information on radio resources for the D2D discovery used in its network or in other network from the network which the terminal subscribes to. Here, the terminal may receive the information on radio resources and configuration related to transmission via at least one system information block (SIB) or a dedicated signaling such as Radio Resource Control (RRC) signaling. The discoverable UE may transmit the open-type discovery message by using frequency spectrum of operator network which the discoverable UE subscribes to, and the discovery UE may receive the open-type discovery message via network of operator which the discovery UE subscribes to or network of other operator and perform the D2D discovery procedure.

For the D2D discovery between terminals which subscribe different operator networks, the terminal is required to be equipped with a receiver which can receive signal from the network of other operator. Alternatively, radio resources for the D2D discovery may be configured to be orthogonal in time domain, for terminals not equipped with the receiver which can receive signal from the network of other operator simultaneously. Networks of operators may exchange configuration information such as radio resource for the D2D discovery in order to support the D2D discovery between terminals which subscribe to different operator networks.

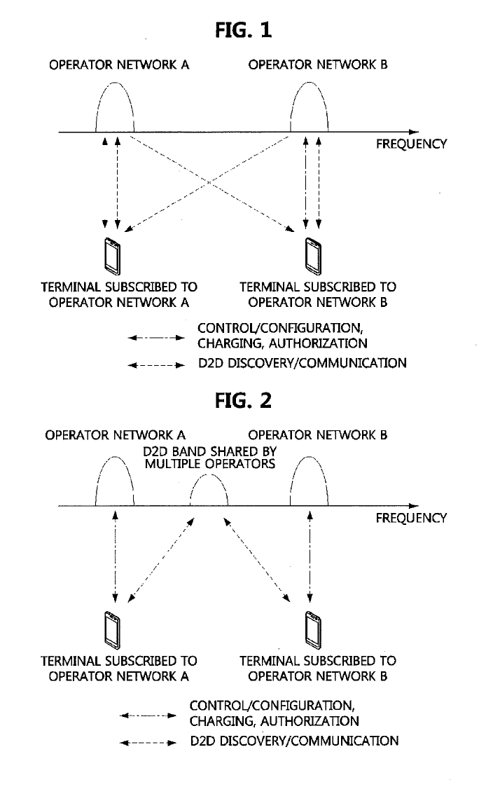

FIG. 2 is a conceptual diagram to depict a dedicated-type spectrum usage model.

Referring to FIG. 2, the terminal may perform the D2D discovery by using a dedicated spectrum separated from the spectrum for cellular communication and shared by a plurality of mobile communication operators to be used for the D2D discovery and communication. A control/configuration, an authentication, and a charging for the D2D discovery may performed via cellular network of operator which the terminal subscribes to.

In the dedicated-type spectrum usage model, the terminal may obtain information on radio resources and configuration related to transmission for the D2D discovery via at least one system information block (SIB) or a dedicated signaling such as Radio Resource Control (RRC) signaling. The discoverable UE may transmit the open-type discovery message by using the dedicated spectrum shared by operators, and the discovery UE may receive the open-type discovery message by using the dedicated spectrum shared by operators and perform the D2D discovery procedure.

Next, functional entities for the D2D discovery and a functional structure for the D2D discovery will be explained hereinafter.

In order to provide the D2D discovery service, a cellular system defines additional functional entities for the D2D discovery and provides features of the D2D discovery using the functional entities. For this, a Discovery Management Entity (DME) and a Discovery Management Function (DMF) may be introduced in the present invention. The DME is a functional entity which manages a function of D2D discovery and The DMF is a functional module which manages the function of D2D discovery. The DME may be located in the operator network or out of the operator network as a functional entity or a server. The DMF may be the functional module which is located in the terminal and works with the DME in order to manage the discovery function.

FIG. 3 is a conceptual diagram to depict a functional structure for D2D discovery.

Referring to FIG. 3, the DME may perform generation and issuing of a discovery identifier (ID), storing information of terminal related to discovery, exchanging information for the D2D discovery between operator networks, and interworking with functional entities of the cellular network. The DME may be an independent functional entity or an additional function in the existing functional entity such as a Mobility Management Entity (MME). A network operator may use at least one DME in order to provide the D2D discovery service. An interface between DMEs of other operator networks may be provided in order to support the D2D discovery between terminals which subscribe to different operator networks, and the configuration information related to the discovery may be exchanged via the interface.

Also, the DME may be distributed as the additional functions embedded in the existing functional entities such as MME and a D2D server. In this case, an interface between the functional entities such as the MME and/or between the D2D server may be provided, and the configuration information related to D2D discovery may be exchanged via the interface.

The DME and DMF may manage states related to the D2D discovery, and the states for D2D discovery transmission and reception may be defined as below table 1.

TABLE 1

| State | Description |
|---|---|
| Idle | not performing procedures related to D2D discovery |
| Discovery | transmitting discovery message for D2D discovery |
| Discoverable | Receiving discovery message for D2D discovery |
| Discovery & | Transmitting and receiving discovery message for D2D |
| Discoverable | discovery |

A first method of the open-type discovery will be explained hereinafter.

Here, the DME is regarded to exist as an independent functional entity, and network operator is regarded to provide the D2D discovery service by using a single logical DME. When a function of the DME is included in an existing functional entity, corresponding interface may be changed.

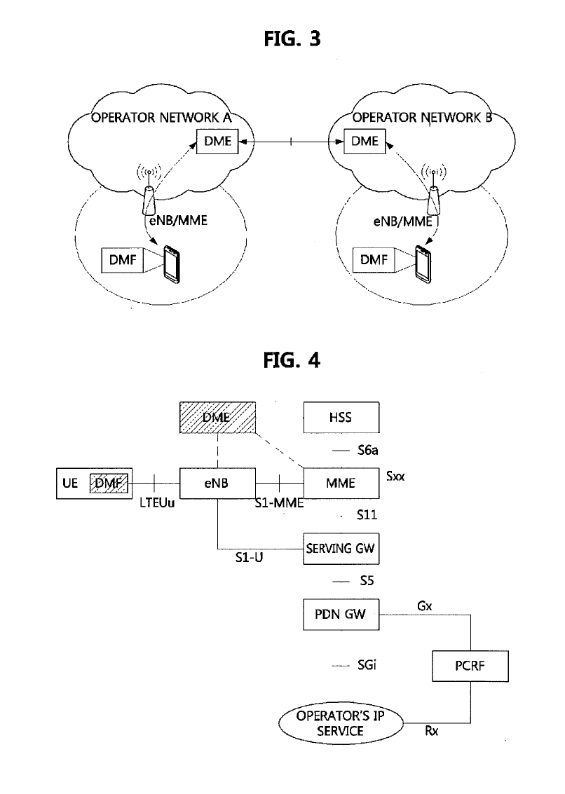

FIG. 4 is a block diagram to depict a structure of cellular network for D2D discovery.

Referring to FIG. 4, the DME may interwork with other functional entities such as a Home Subscriber Server (HSS), a MME, and a base station (eNB etc.) by using additional reference points. The DMF located in the UE may store information related to the D2D discovery. The DMF may perform procedures of D2D discovery based on the stored information related to the D2D discovery by interworking with functions of LTE protocol which functions related to the D2D discovery are added to, with D2D discovery applications. Here, the D2D discovery applications may be located in the UE. The DMF may be included in an existing function or may exist as an independent function as similar to the case of the DME. Hereinafter, the DMF is supposed to exist as the independent function.

FIG. 5 is a conceptual diagram to show an example embodiment of a functional structure of terminals for D2D discovery.

Referring to FIG. 5, a RRC layer, a MAC layer, and a PHY layer of protocol stack for D2D discovery may include additional functions for D2D discovery, and other layers except the three layers are the same with those of conventional UE.

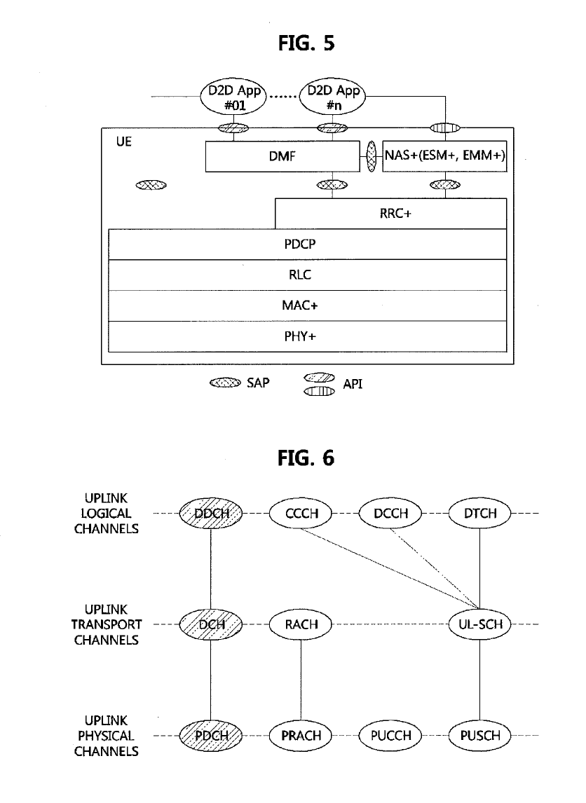

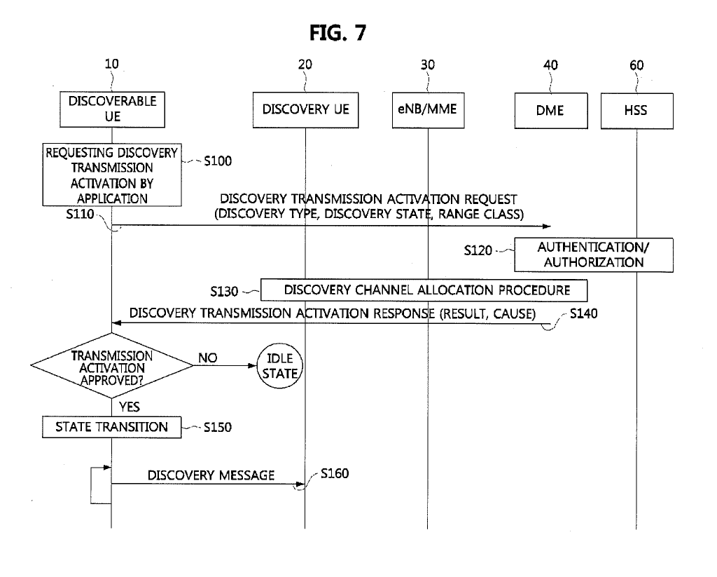

FIG. 6 is a conceptual diagram to depict channel mapping of uplink channels defined for D2D discovery.

Referring to FIG. 6, procedures of control protocol for D2D discovery can use an existing layer structure and uplink/downlink channels of a cellular system. That is, a Dedicated Control Channel (DCH), a Downlink Shared Channel (DL-SCH), and a Physical Downlink Shared Channel (PDSCH) of uplink channels may be used and a Downlink Dedicated Control Channel (DDCH), a Downlink Shared Channel (DL-SCH), and a Physical Downlink Shared Channel of uplink channels may be used. For exchanging D2D discovery messages between UEs, a DDCH, a Dedicated Channel (DCH), and a Physical Dedicated Channel (PDCH), which are newly defined, may be used.

The mobile network operator can provide a discovery management server for user's D2D service subscription, registration and configuration, and discovery applications for UEs in addition to the above-described DME and DMF.

The discovery management server and the discover applications are for one example business operation of network operators in order to provide users with discovery services, and the detail explanation on them is omitted in this specification.

For the open-type discovery, the DME may be configured to perform some or all of functions described in below table 2.

TABLE 2

| | |
|---|---|
| Functions | Managing open-type discovery service subscriptions |
| | Generating and issuing discovery ID |
| | Authenticating third-party applications |
| | Managing discovery configuration information |
| | (discovery type, discovery state) |
| | Mediating open-type discovery information by |
| | interworking with DME |
| | Performing procedures of D2D discovery by |
| | interworking with DMF |
| | Interworking with functional entities of LTE network, |
| | such as MME, eNB and HSS, for authentication and |
| | charging |
| Information | Discovery ID of a terminal and an unique ID of the terminal |
| stored | Additional information related to services |
| | (extended service codes and/or general information, |
| | information on URL of server having detail information |
| | related services |
| | Range class |
| | Contract information of third party applications |

The DMF may be configured to perform some or all of functions described in below table 3.

TABLE 3

| | |
|---|---|
| Common | Providing interface to applications |
| Functions | Supporting authentication of third party applications |
| | Performing protocol procedures for D2D discovery by |
| | interworking with DME |
| | Interworking with applications related to discover and |
| | LTE protocol of terminal |

| | | |
|---|---|---|
| Functions in | Functions | Generating and transmitting open-type |
| discoverable | | discovery message |
| state | Information | Open-type discovery service code |
| | stored | Discovery ID issued |
| | | Range class |
| Functions in | Functions | Receiving and filtering open-type discovery |
| discovery | | message |
| state | | Requesting discovery information to DME |
| | | and receiving it from DME (and filtering) |
| | | Transmitting discovery information |
| | | (received and filtered) to application |
| | | Reporting open-type discovery events and |
| | | charging information to network |
| | Information | Service code (temporary) |
| | stored | |

Next, operation procedures according to the first method of open-type discovery will be explained hereinafter.

Registering Open-Type Discovery transmission Service and Generating Discovery Information

The registration may mean procedure for registering open-type discovery service based on information input by open-type discovery service provider, and the generating may mean procedure for generating discovery information for service provisioning. The discovery information obtained from the procedure may be used in transmitting open-type discovery message of UE. Through the above-described procedures, an open-type discovery ID may be issued. The issued single discovery ID can be used for both the open-type discovery and the restricted-type discovery.

The registration and the generating procedure for the discoverable UE may be classified into two cases as follows. A first case is that the discovery information is generated through access to a server of mobile network operator, and a second case is that an application of UE generates the discovery information.

1) The First Case

An user can perform selecting service category to which a service to be provided belong, inputting additional information related to the service, and inputting address information (URL information) of a server providing detail information related to the service, by accessing a discovery service management server operated by mobile network operator via an UE or a PC. And then, if the user requests open-type discovery transmission service, the discovery service management server may transmit the information on the selected service category or a service code generated from the selected service category with other information to the DME located in the network.

When the DME receives the information on the selected service category, the DME may generate the service code based on the information, issue the generated service code for the UE, report a result to the discovery service management server, and complete the service registration procedure. Meanwhile, when the DME receives the service code generated from the selected service category, the DME may issue the received service code for the UE, report a result to the discovery service management server, and complete the service registration procedure. Here, the DME may generate a discovery ID, and provide the discovery ID with the service code to the UE. Here, the DME may store a portion of the service code (extended part) or the whole service code.

2) The Second Case

The application located in the discoverable UE may generate the service code, and the method of generating the service code in the application may be classified into two solutions as follows.

The first solution is for the application to generate the service code by itself, and the second solution is for the application to generate the service code based on a support of the DME.

In the first solution, the user selects service category which the service to be provided belong to, inputs additional information related to the service, inputs address information (URL information) of a server providing detail information related to the service and requests registration to open-type discovery transmission service, by using the application. Then, the application may generate the service code based on the selected service category, and provide the generated service code and other additional information to the UE. The UE may provide the generated service code and the other additional information to the DME of the network, and the DME may report a result of receiving the information to complete procedure of service registration. In this case, the DME may generate a discovery ID and transmit the discovery ID with the generated service code to the UE. A configuration change of service category may be applied to the application by an update procedure, and the update procedure may be performed if necessary.

In the second solution, all the steps are similar to the first solution, the only difference between the first solution and the second solution is that the information on the selected service category are provided to the DME, and the DME generates the service code based on the received information. The DME may change service code by providing the changed service code to the UE when a change of the service code is needed due to a configuration change of service category.

The DME may store a portion of the service code (extended part) or the whole service code. The service code may be defined by mobile network operators and shared by the mobile network operators based on contracts between the mobile network operators. In the procedure of open-type discovery transmission service registration, the DME may store the ID and the discovery ID of each UE as they are mapped to each other.

Authentication of Open-Type Discovery Application

An authentication procedure of the open-type discovery application may mean a procedure of application located in the discoverable UE performing service by using the open-type discovery function.

Activation of Open-Type Discovery Transmission

An open-type discovery transmission activation procedure is a procedure which enables the discoverable UE to transmit a discovery message by using allocated radio resources.

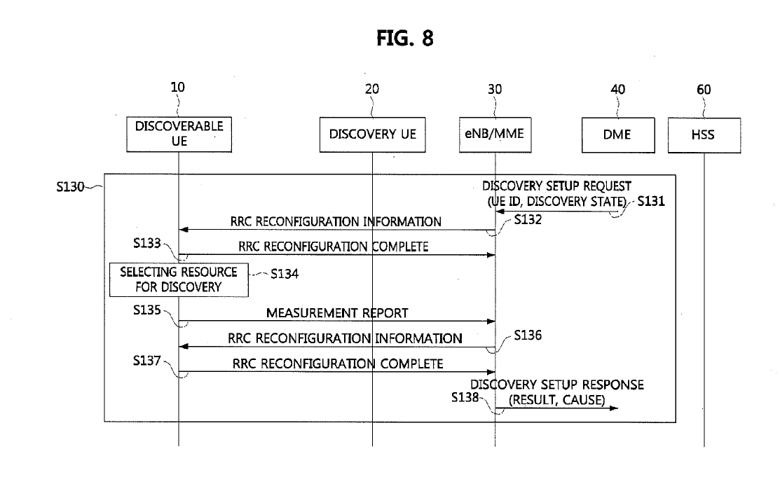

FIG. 7 is a sequence chart showing an open-type discovery transmission activation procedure of discoverable UE, and FIG. 8 is a sequence chart showing a discovery channel allocation procedure in FIG. 7.

The user may request an approval on transmitting the open-type discovery transmission by using the application located in the UE (S100). The discoverable UE 10 may transmit a discovery transmission activation request (ACTIVATE_DISCOVERY_REQ) to the DME 40 according to the request from the user (S110). The discovery transmission activation request may include information on a discovery type, a discovery state, and a range class. The DME 40 which has received the discovery transmission activation request may perform an authorization/authentication on activation of the discovery transmission with a HSS 60 (S120).

Then, the DME 40 may perform a discovery channel allocation procedure for D2D discovery (S130). The DME 40 may transmit a discovery setup request (DISCOVERY-SETUP_REQ) including an ID of the discoverable UE and the discovery state information to an eNB/MME 30 (S131). The eNB/MME 30 may transmit a radio resource control (RRC) reconfiguration information (rrcReconfig+) to the discoverable UE 10 based on the discovery setup request (DISCOVERY_SETUP_REQ) (S132). The discoverable UE 10 may transmit a RRC reconfiguration complete to the eNB/MME 30 in response to the radio resource control (RRC) reconfiguration information (S133). Based on this, the UE 10 may select resources for the discovery (S134), and transmit a measurement report (measurementReport+) on the selected discovery resources to the eNB/MME 30 (S135). The eNB/MME 30 may transmit an RRC reconfiguration information (rrcReconfig+) to the UE 10 (S136). The UE 10 may transmit an RRC reconfiguration complete message to the eNB/MME 30 in response to the RRC reconfiguration information (rrcReconfig+) (S137). By this procedure, the eNB/MME 30 may transmit a discovery setup response (DISCOVERY_SETUP_RSP) including information on allocated radio resource information to the DME 40 (S138).

The DME 40 may transmit a discovery transmission activation response (ACTIVATE_DISCOVERY_RSP) to the UE 10 in response to the discovery transmission activation request (ACTIVATE_DISCOVERY_REQ) (S140). If the discovery transmission activation response includes a negative response, the UE 10 may be transitioned to an idle state. On the contrary, if the discovery transmission activation response includes a positive response, the UE may be transitioned to a discoverable state or a discoverable/discovery state (S150).

Then, the discoverable UE 10 may transmit a discovery message (DISCOVERY_MSG) (S160). Here, the discovery message may include information on a service code, a discovery ID corresponding to the UE 10 and etc.

Open-Type Discovery Service

An open-type discovery service procedure is a procedure for a discovery UE to receive the open-type discovery message (transmitted by the discoverable UE), perform following procedures based on the received discovery message, and provide a proximity based service to the user.

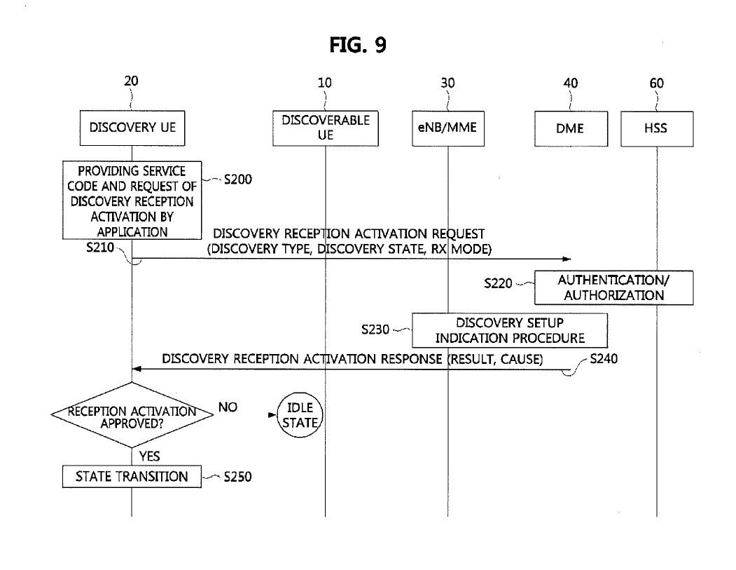

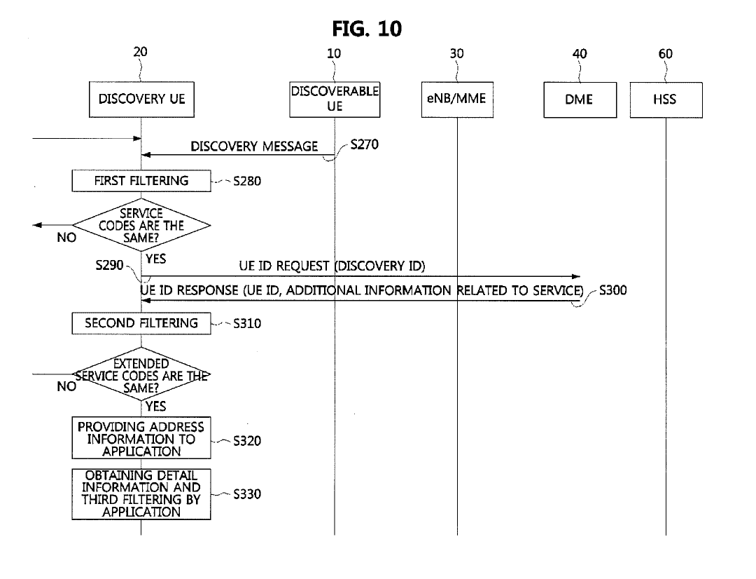

FIG. 9 is a conceptual diagram to depict a discovery service procedure, and FIG. 10 is a conceptual diagram to depict a filtering procedure of the discovery service procedure.

The user may select the service category of the service to be desired by using application equipped in the discovery UE 20, and may input keyword to select the desired service if the application supports the keyword search function so as to request the open-type service discovery. The application may generate the service code based on the selected service category and transmit the generated service code to the UE 20, and request an activation of the open-type discovery reception.

The UE 20 may transmit a discovery reception activation request (ACTIVATE_DISCOVERY_REQ) to the DME 40 for receiving a discovery message according to the request (S210). The discovery reception activation request may include information on a discovery type, a discovery state, and a reception mode (rx mode). The DME 40 which has received the discovery reception activation request (ACTIVATE_DISCOVERY_REQ) may perform an authorization/authentication on activation of discovery reception with the HSS 60 (S220).

The DME 40 may perform a discovery setup indication procedure for transferring a discovery state of the UE 20 to the eNB/MME 30 which the UE 20 belongs to (S230). By this procedure, the eNB may find the discovery state of the UE 20 and use this information for radio resource scheduling on the UE 20. The DME 40 may transmit a discovery reception activation response (ACTIVATE_DISCOVERY_RSP) to the UE 20 in response to the discovery reception activation request (ACTIVATE_DISCOVERY_REQ) (S240). Here, the discovery reception activation request (ACTIVATE_DISCOVERY_REQ) may include information on radio resources used for receiving the open-type discovery message.

If the discovery reception activation response includes a negative response, the UE 20 may be transitioned to an idle state. On the contrary, if the discovery reception activation response includes a positive response, the UE 20 may be transitioned to a discovery state or a discoverable/discovery state (S250).

The UE 20, which has been transitioned to the idle state, may search the open-type discovery message (DISCOVERY_MSG) transmitted by the discoverable UE on the radio resources indicated by a system information received from a base station, a dedicated signaling, or the information on radio resources included in the discovery reception activation response (S270). The UE 20 may perform the searching continuously until the UE 20 receives a deactivation request from the application or the UE 20 determines stopping the searching.

The UE 20 may perform a first filtering on received discovery messages when the UE 20 receives the discovery messages transmitted from discoverable UEs including the UE 10 through searching the discovery message (S280). That is, the UE 20 may determine whether the service code provided from the application is the same with a service code included in the received discovery message or not. When the service codes are the same, the discovery UE 20 may transmit an UE identity request (UE_IDENTITY_REQ) to the DME 40 by using the discovery ID included in the discovery message (S240).

The DME 40 may transmit a UE identity response (UE_IDENTITY_RSP) to the UE 20 in response to the UE identity request (UE_IDENTITY_REQ) (S300). The UE identity response may include information on an ID of the discoverable UE 10, an extended service code, and an URL information of service providing detail information related to service.

The UE 20 may perform a second filtering based on the UE identity response (UE_IDENTITY_RSP) (S310). As one example embodiment, the UE 20 may determine whether the extended service code provided from the application is the same with a service code included in the received UE identity response. When the service codes are the same, the URL information provided by the DME may be provided to the application of the UE 20 (S320). Here, the second filtering is optional, and may not be adopted.

If not filtered by the second filtering (only by the first filtering if the second filtering is not adopted), the UE 20 may provide the address information (that is, the UE ID and/or the URL information of server providing the detail information) to the application. The address information may be used for obtaining the detail information or for a third filtering (S330).

As one example embodiment, the application may form a network with the discoverable UE transmitting the open-type discovery message by using the UE ID, and obtain the detail information related to provided service and related keyword information from the discoverable UE. Also, the application may obtain the further detail information from the server by accessing the server proving the detail information related to service using the URL information.

The method of presenting the obtained information to the user may be classified into two cases, a first one is representing the detail information to the user instantly after obtaining the detail information, and a second one is representing the detail information to the user after completion of the third filtering.

The first one is presenting the obtained detail information immediately after obtaining the information without any further processing. In this case, the URL information of the server may be presented to the user with the other information, for the user to access the server directly with it, when the URL information has been received as the additional information.

The second one is presenting the obtained detail information to the user after completion of the third filtering. That is, the application may perform the third filtering, which is a filtering performed by matching a keyword in natural language inputted by the user, in order to filter the service which is highly related to the service the user requires and present the obtained information of the filtered service to the user. In this case, the URL information of the server may be presented to the user with the other information, for the user to access the server directly with it, when the URL information has been received as the additional information.

In performing the above described open-type discovery service procedure, a case that the UEs are located in the same network of the same network operator and a case that the UEs are located in different networks of different network operators may be considered for the procedure of receiving the UE ID corresponding to the discovery ID and the additional information. Especially, in the latter case, the procedure of receiving the UE ID corresponding to the discovery ID and the additional information may be performed by interworking of the DMEs of the different networks.

Deactivation of Open-Type Discovery Transmission

An open-type discovery deactivation procedure may include a procedure of terminating the activated discovery transmission and a procedure of terminating the open-type discovery service.

The procedure of terminating the activated discovery transmission may be started by a request from the application or by a decision of the discovery UE itself. The discovery UE may transmit a discovery deactivation request information to the DME. The DME which has received the discovery deactivation request information may request a base station to recover the channel (radio resources) for the open-type discovery, and provide a result (that is, a discovery transmission deactivation response) to the discovery UE. The discovery UE which has received the response may stop transmitting the open-type discovery message and transition to an idle state or a discovery state.

The procedure of terminating the open-type discovery service may be started by a request of the application, and the discovery UE which received the request may transmit a discovery service deactivation request information to the DME. The DME which has received the discovery service deactivation request information may report it to the base station and provide a discovery service deactivation response in response to the discovery service deactivation request information. The discovery UE which has received the response may stop searching the open-type discovery message.

Reporting Open-Type Discovery Events and Searched Information

A procedure of reporting open-type discovery events and searched information may mean a procedure of reporting events generated in the D2D discovery procedures and information obtained through the D2D discovery procedures.

Exchanging Information Related to Discovery Between DMEs

A procedure of exchanging information between DMEs may mean a information exchange procedure which enables discovery procedure between terminals managed by different DMEs. Especially, a discovery procedure between terminals which subscribe to different operator networks may be enabled through the information exchange procedure. The information exchange procedure may include a procedure of transmitting information on spectrum used for discovery and information on radio resource allocation, which are managed by a respective DME of each operator network, and transmitting protocol messages for the above-described open-type discovery transparently. The information exchanged between the DMEs and the information exchange procedure will be explained.

Spectrum & Radio Resource Configuration Information
Information on spectrum for discovery: the DME may transmit information on resource configuration for discovery of a cell managed by the DME to the counterpart DME.

Application Authorization Procedure
The DME may transmit protocol messages for the above-described application authorization procedure to the counterpart DME, and the protocol messages may be encapsulized.

UE ID Exchange Procedure
Exchanging protocol messages for the above-described UE ID acquisition procedure with the counterpart DME, in which the protocol messages may be encapsulized.

Discovery Information Report Procedure
Exchanging protocol messages for the above-described open-type discovery reporting procedure with the counterpart DME, in which the protocol messages may be encapsulized.

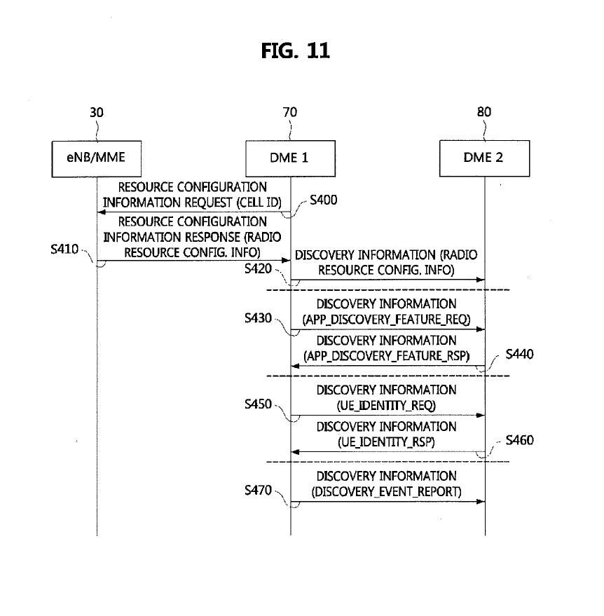

FIG. 11 is a sequence chart to depict a discovery configuration information exchange procedure between DMEs.

Referring to FIG. 11, a first DME 70 and a eNB/MME 30 are located in the same network, and a second DME 80 is located in a different network with that of the first DME 70 and the eNB/MME 30.

In the radio configuration information exchange procedure, the first DME 70 may transmit a resource configuration information request (RESOURCE_CONFIG_INFO_REQ) to the eNB/MME 30 (S400). The resource configuration information request may include a cell ID. The eNB/MME 30 may transmit a resource configuration information response (RESOURCE_CONFIG_INFO_RSP) to the first DME in response to the resource configuration information request (RESOURCE_CONFIG_INFO_REQ) (S410), and the resource configuration information response may comprise information on radio resource configuration. The first DME 70 may transmit a discovery information (DISCOVERY_INFO_XFER) including the radio resource configuration to the second DME 80 (S420).

In the application authorization procedure, the first DME 70 may transmit a discovery information (DISCOVERY_INFO_XFER) including an application discovery feature request (APP_DISCOVERY_FEATURE_REQ) to the second DME 80 (S430). The second DME 80 may transmit a discovery information (DISCOVERY_INFO_XFER) including a discovery feature response (APP_DISCOVERY_FEATURE_RSP) in response to the discovery information to the first DME 70 (S440).

In the UE ID exchange procedure, the first DME 70 may transmit a discovery information (DISCOVERY_INFO_XFER) including an UE ID request (UE_IDENTITY_REQ) to the second DME 80 (S450). The second DME 80 may transmit a discovery information (DISCOVERY_INFO_XFER) including an UE ID response (UE_IDENTITY_RSP) in response to the discovery information to the first DME 70 (S460).

In the discovery information report procedure, the first DME 70 may transmit a discovery information (DISCOVERY_INFO_XFER) including a discovery event report (DISCOVERY_EVENT_REPORT) to the second DME 80 (S470).

Meanwhile, a configuration of information for the open-type discovery will be explained hereinafter. The information for the open-type discovery may mean information transmitted and received for the open-type discovery. The information may include a discovery ID identifying a terminal, a service code identifying a service of an UE transmitting the open-type discovery information. The discovery ID is required not to occur any security problems even when it is disclosed, and the service code is required to be defined and shared by a discovery UE and a discoverable UE according to a mutual commitment of the UEs.

The D2D discovery message for the open-type discovery may include a message type, a discovery ID, and a service code. The message type represents a type of the D2D discovery message, and may be omitted if the D2D discovery message can be identified whether it is for an open-type discovery or a restricted-type discovery by other methods (for example, using different radio resource groups for the open-type discovery and the restricted-type discovery). The discovery ID is information used for identifying an UE transmitting the D2D discovery message (a discoverable UE), and the discovery ID and the UE ID may have an one-to-one relationship. The service code may mean information on the service category indicated by user or application.

The message type of the D2D discovery message for the open-type discovery may have a length of N bits, and it may be defined as below table 4, for example, when N is 2.

TABLE 4

| Message type | Meaning |
|---|---|
| 00 | Restricted-type D2D discovery information |
| 01 | Open-type D2D discovery information |
| 10 | Signaling information |
| 11 | Reserved |

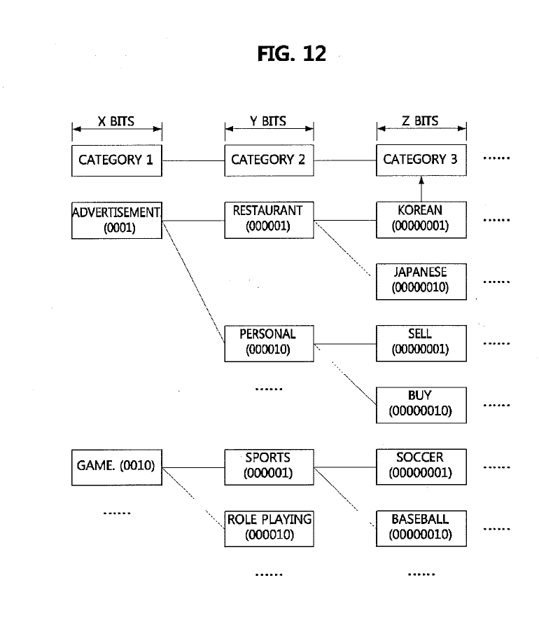

FIG. 12 is a view to depict an example embodiment of service category information configuration.

Referring to FIG. 12, the service code included in the open-type discovery message may represent service category information of a discoverable UE, and the categories may have a hierarchical structure.

For example, a category1 may be classified into an advertisement 0001 and a game 0010. A category2 may be classified into a restaurant 000001, a personal 000010, a sports 000001, and a role-playing 000010. A category3 may be classified into a Korean 00000001, a Japanese 00000010, a selling 00000001, a buying 00000010, a football 00000001, and a baseball 00000010.

The discovery ID included in the open-type discovery message may be used for obtaining an UE ID and additional information corresponding to it. The discovery UE may perform a query procedure with the DME based on the discovery ID included in the open-type discovery message, and obtain the UE ID of the discoverable UE and the additional information corresponding to the discovery ID.

The discovery ID may be defined as a globally unique ID or a regionally unique ID. In the case of the global unique ID, since the discovery ID is globally unique, a change of the discovery ID of the UE is not necessary when the UE moves to other region. On the contrary, in the case of the regional unique ID, a change of the discovery ID is necessary when the UE moves to other region.

FIG. 13 is a view to depict an example embodiment of D2D discovery message configuration.

Referring to FIG. 13, a configuration of the open-type discovery message is shown in the case that the global unique discovery ID is used as the discovery ID. The open-type discovery message (that is, a device discovery message) may have a length of 128 bits, and include a discovery type of 2 bits, a discovery ID of 64 bits, and a service code of 64 bits. The discovery ID may be configured as a hierarchical structure including a mobile country code (MCC) and a mobile identifier (ID), which is similar to an international mobile subscriber identity (IMSI) used for the conventional LTE. Among these, the mobile ID may be configured arbitrarily by network operator.

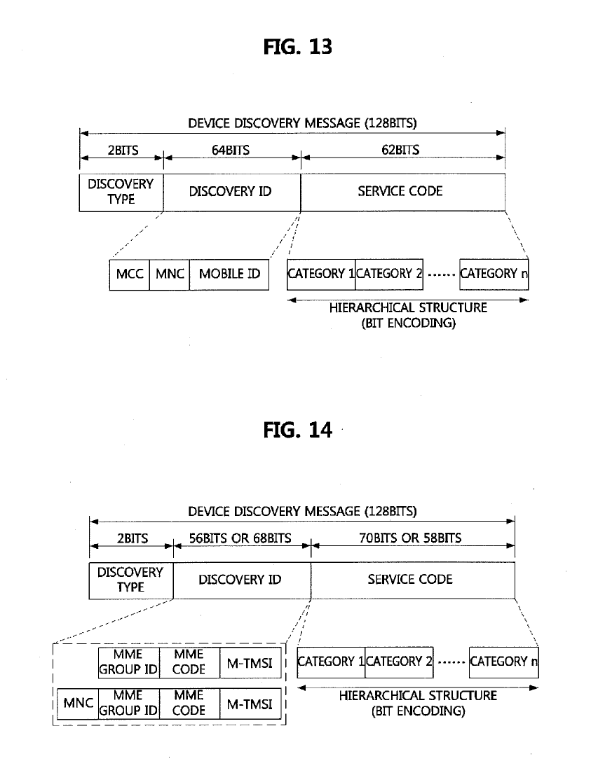

FIG. 14 is a view to depict another example embodiment of D2D discovery message configuration.

Referring to FIG. 14, a configuration of the open-type discovery message is shown in the case that the regional unique discovery ID is used as the discovery ID. The open-type discovery message (that is, a device discovery message) may have a length of 128 bits, and include a discovery type of 2 bits, a discovery ID of 56 or 68 bits, and a service code of 70 or 58 bits. The discovery ID may be configured as a hierarchical structure including a MCC, a MNC, a MME group ID, a MME code and a MME temporary mobile subscriber identity (M-TMSI), or as a hierarchical structure including a MME group ID, a MME code and a M-TMSI, which are similar to a globally unique temporary UE identity (GUTI) used for the conventional LTE. Also, the discovery ID has a configuration which excludes the MCC from the above-described global unique ID. That is, the discovery ID may be configured as a hierarchical structure including a MNC, a MME group ID, a MME code and a M-TMSI.

A second method of the open-type discovery will be explained hereinafter.

As compared with the above-described first method, the second method has differences as follows.
A D2D server is included as a functional entity for the second method, and provides a D2D discovery service.
A MME may perform some functions of a DME, and a D2D server may perform the rest of functions. That is, the functions of the DME explained in the first method may be divided into two parts, and the MME and the D2D server perform a respective part of the two parts.
The D2D server is configured to generate, issue and recover a discovery ID when necessary.

Operation procedures for the second method of the open-type discovery will be explained as follows.

Open-Type Discovery Transmission Service Registration Procedure

A procedure of open-type discovery transmission service registration may mean a procedure for an open-type discovery service provider to input necessary information and register the open-type discovery service.

The procedure of open-type discovery transmission service registration in the second method may be classified into three cases, in accordance whether information exchange between the UE and the D2D server is performed using a control plane and/or an user plane.

Case 1) Information Exchange Performed Using Control Plane

In this case, the D2D server perform a role of the DME, and the discovery ID is not provided to the UE together when service code is provided. The rest except the above difference is the same with the above-described first method of open-type discovery.

Case 2) Information Exchange Performed Using User Plane

In this case, the UE may access the D2D server directly, and thus the user desiring to provide the open-type discovery service may select service category and input detail information related to service to be provided, by accessing the D2D server. For example, the user wanting to provide an advertisement on a restaurant may input service related detail information as follows
A title of the restaurant, a menu, a recommended menu, available park lots, available seats, information on discount coupons, address, telephone number, an uniform resource identifier (URI) of the UE providing the open-type discovery service, other information introducing the restaurant, an URL of homepage, a photographic menu, a photograph of the restaurant etc.

Then, when the user requests an open-type discovery transmission service registration, the D2D server may generate a service code based on the selected service category, provide the generated service code to the UE and complete the procedure of service registration.

Case 3) Information Exchange Performed Using Control Plane and User Plane

In this case, the UE also may access the D2D server directly, and thus the service registration may be performed in the same manner with the case 2.

Authentication of Open-Type Discovery Application

A procedure of authentication may mean a procedure for authenticating discovery applications located in an UE which performs services by using the open-type discovery function, and be the same with the authentication procedure in the first method of open-type discovery.

Open-Type Discovery Transmission Activation and Service

A procedure of open-type discovery transmission activation and service is a procedure that the discoverable UE transmits the open-type discovery message by using the allocated radio resources, the discovery UE receives the open-type discovery message, and a following operations based on the received message are performed to provide a proximity service to the user.

The procedure of activating the open-type discovery transmission in the second method may be classified into three cases, in accordance whether information exchange between the UE and the D2D server is performed using a control plane and/or an user plane.

Case 1) Information Exchange Performed Using Control Plane

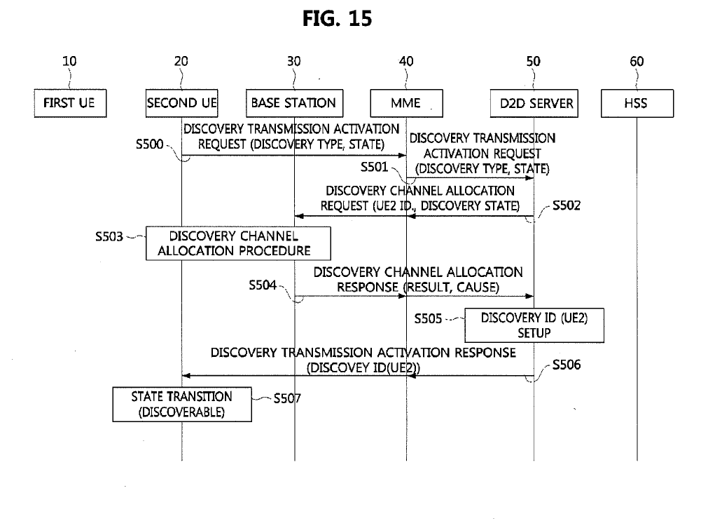

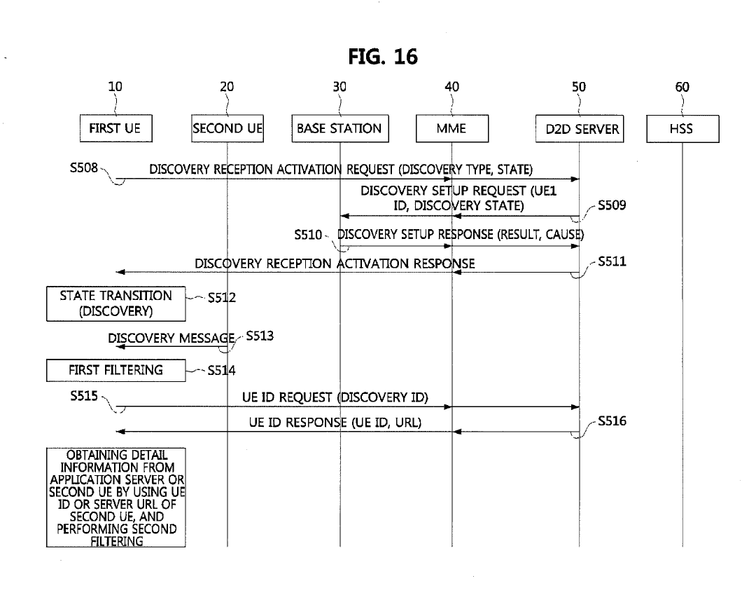

FIG. 15 is a sequence chart to depict a procedure of open-type discovery transmission activation using a control plane, and FIG. 16 is a sequence chart to depict a procedure of open-type discovery service using a control plane.

The use may select a service to be provided and request an open-type discovery transmission, a second UE 20 may transmit a discovery transmission activation request (ACTIVATE_DISCOVERY_REQ) to a MME 40 (S500). The discovery transmission activation request (ACTIVATE_DISCOVERY_REQ) may include a discovery type and a discovery state.

The MME 40 which has received the discovery transmission activation request (ACTIVATE_DISCOVERY_REQ) may provide it to a D2D server 50 (S501), the D2D server 50 may transmit an open-type discovery channel setup request (DISCOVERY_SETUP_REQ) to a base station 30 via the MME 40 for a second UE 20 (S502). The open-type discovery channel setup request (DISCOVERY_SETUP_REQ) may include the UE ID and a discovery state of the second UE 20.

The, the base station 20 may perform a procedure of open-type discovery channel setup with the second UE 20 (S503), and provide a discovery channel setup response (DISCOVERY_SETUP_RSP) an open-type discovery channel setup request (DISCOVERY_SETUP_REQ), as a result of channel allocation, to the D2D server 50 via the MME 40 (S504). According to this, the D2D server 50 may generate d discovery ID of the second UE 20 (S505), provide a discovery transmission activation response (ACTIVATE_DISCOVERY_RSP) to the second UE 20 via the MME 40 (S506). The second UE 20 which has received the discovery transmission activation response (ACTIVATE_DISCOVERY_RSP) may transitioned to a discoverable state (S507), may transmit the open-type discovery message using the allocated radio resources after transitioned to the discoverable state.

The procedure of the open-type discovery service may mean a procedure that the discovery UE receives the open-type discovery message by using the allocated radio resources, and a following operations based on the received message are performed to provide a proximity service to the user. The procedure of the open-type discovery service is as follows.

The user may select a service (for example, by using the hierarchical structure) which the user want to be served by using an application of the first UE 10, or input a keyword to find the desired service if the first UE 10 (that is, the application of the first UE) supports a keyword searching function, in order to request the open-type discovery service. The first UE 10 which received the request of the user may generate a service code based on the selected service. The first UE 10 may transmit an open-type discovery reception activation request (ACTIVATE_DISCOVERY_REQ) to the MME 40, the MME 40 may transmit the open-type discovery reception activation request (ACTIVATE_DISCOVERY_REQ) to the D2D server 50 (S508). The open-type discovery reception activation request (ACTIVATE_DISCOVERY_REQ) may include a discovery type and a discovery state.

The base station 30, the MME 40, and the D2D server 50 may perform a discovery setup indication procedure. That is, the D2D server 50 may transmit a discovery setup request (DISCOVERY_SETUP_REQ) to the base station 30 via the MME 40 (S509), and the base station 30 may transmit a discovery setup response (DISCOVERY_SETUP_RSP) to the D2D server 50 via the MME 40 in response to the discovery setup request (S510). The discovery setup request (DISCOVERY_SETUP_REQ) may include the UE ID and the discovery state of the first UE 10. The discovery setup response (DISCOVERY_SETUP_RSP) may include a result according to the discovery setup request and cause information on the result.

The D2D sever 50 may indicate the first UE 10 to transition to the discovery state by transmitting the discovery reception activation response (ACTIVATE_DISCOVERY_RSP) via the MME 40 (S511). The first UE 10 may transition to the discovery state based on the discovery reception activation response (ACTIVATE_DISCOVERY_RSP) (S512). The, the first UE 10 may select radio resources used for receiving the open-type discovery message based on system information or a dedicated signaled information, and receive the open-type discovery message through the selected radio resources (S513). In this case, the first UE 10 may perform searching the discovery message continuously until the discovery reception is stopped by a request of the application or the UE.

When the open-type discovery message has been received, the first UE 10 may perform a first filtering by comparing a service code generated based on service category selected by the user in requesting the open-type discovery service, and a service code included in the open-type discovery message received (S514). The service code for the first filtering may be defined by mobile network operators and defined as a standardized form. Also, the service code may have a hierarchical structure for an easy identification and selection of services.

When the service code generated based on service category selected by the user is the same with the service code included in the open-type discovery message received, the first UE 10 may request the D2D server 50 to provide service related information by the discovery ID of the second UE 20 included in the open-type discovery message (S515). That is, the first UE 10 may transmit an UE ID request (UE_IDENTITY_REQ) to the D2D server 50, and the UE ID request (UE_IDENTITY_REQ) may include the discovery ID included in the open-type discovery message received. The D2D server may provide the UE ID (for example, a telephone number, an URI, and etc.) of the second UE 20 and/or URL information on a homepage of the second UE user to the first UE 10 (S516). That is, the D2D server 50 may provide an UE ID response (UE_IDENTITY_RSP) including information on the UE ID and the URL information to the first UE 10.

According to the provided information and an user configuration, the first UE 10 which received the related information may perform as follows.
The first UE 10 may form a network with the second UE 20 based on a cellular communication or a D2D communication, so as to obtain the above-described detail information from the second UE. If a second filtering is supported by the first UE (that is, by the application of the first UE), the second filtering, to determine a degree of matching between the keywords inputted previously and the detail information, may be performed.
Alternatively, the first UE may access an application server based on the received URL and obtain the detail information or contents of the homepage, and perform the second filtering when possible as previously described.
Alternatively, the first UE 10 may obtain the detail information or supplementary service information by receiving information broadcasted or multicasted from the second UE through a separate procedure.

Through these procedures, the detail information or the supplementary service may be provided to the user of the first UE.

In performing the above described open-type discovery service procedure, a case that the UEs are located in the same network of the same network operator and a case that the UEs are located in different networks of different network operators may be considered for the procedure of receiving the UE ID corresponding to the discovery ID and the detail information. Especially, in the latter case, the procedure of the open-type discovery service may be performed by interworking of the network functional entities such as MMEs or GWs.

Case 2) Information Exchange Performed Using User Plane

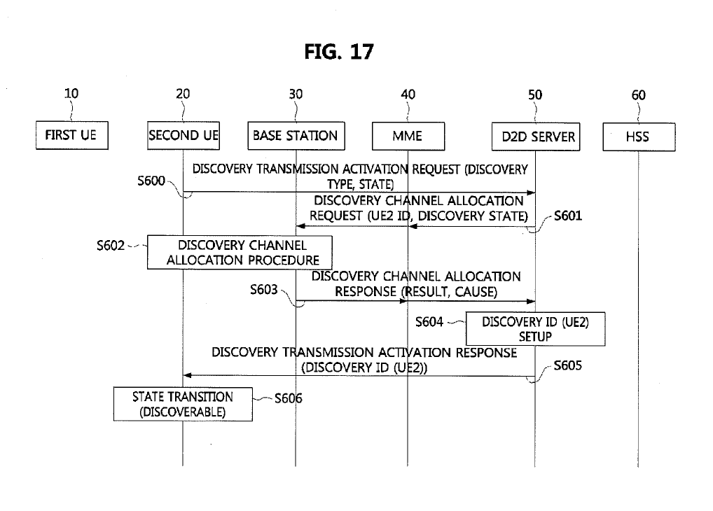

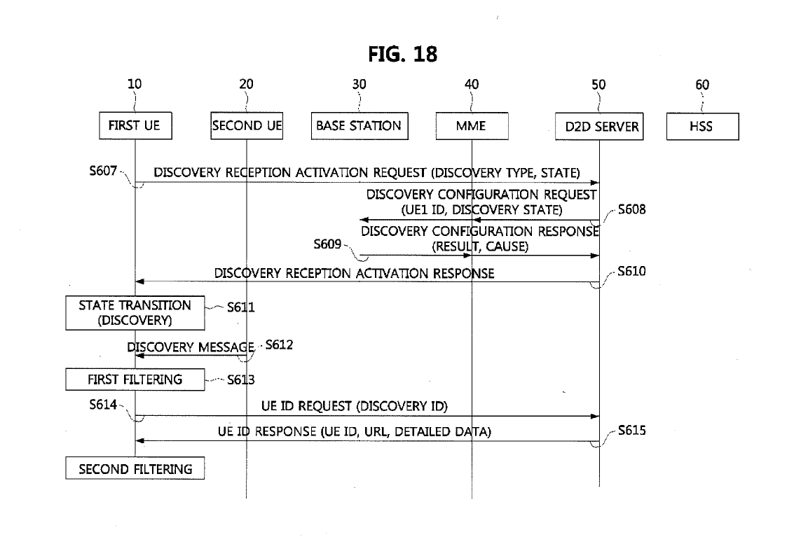

FIG. 17 is a sequence chart to depict a procedure of open-type discovery transmission activation using an user plane, and FIG. 18 is a sequence chart to depict a procedure of open-type discovery service using an user plane.

Other steps of the open-type discovery transmission activation procedure are the same with those of the case 1, and the only difference is that the second UE 20 may request the discovery transmission activation directly to the D2D server 50 through the user plane not via the MME 40.

The procedure of the open-type discovery service of the case 2 has following two different points compared with the case 1. The first one is that discovery reception activation request and discovery reception activation response are exchanged between UE 10 and D2D server 50, directly. The other one is that steps following after the step of performing the first filtering based on the received open-type discovery message. That is, when the service code generated based on the request of the user is the same with the service code included in the open-type discovery message received, the first UE 10 may request the D2D server 50 to provide service related information by using the discovery ID of the second UE 20 included in the open-type discovery message. The D2D server, which received the request, may provide the UE ID (for example, a telephone number, an URI, and etc.) of the second UE 20 and/or URL information on a homepage of the second UE user to the first UE 10.

If the second filtering is supported by the first UE (that is, by the application of the first UE), the second filtering, to determine a degree of matching between the keywords inputted previously and the detail information, may be performed. If the determined degree of matching meets a predefined criteria, the detail information may be provided to the user of the first UE 10.

The following supplementary services may be provided to the user of the first UE 10 based on the detail information.
The first UE 10 may form a network with the second UE 20 based on a cellular communication, so as to obtain further supplementary information from the second UE and provide the obtained information to the user.
Alternatively, the first UE 10 may obtain further supplementary information by accessing an application server based on the received URL, and provide the obtained information to the user.
Alternatively, the first UE 10 may obtain additional information or supplementary service information by receiving broadcasted or multicasted information through a separate procedure.

Case 3) Information Exchange Performed Using Control Plane and User Plane

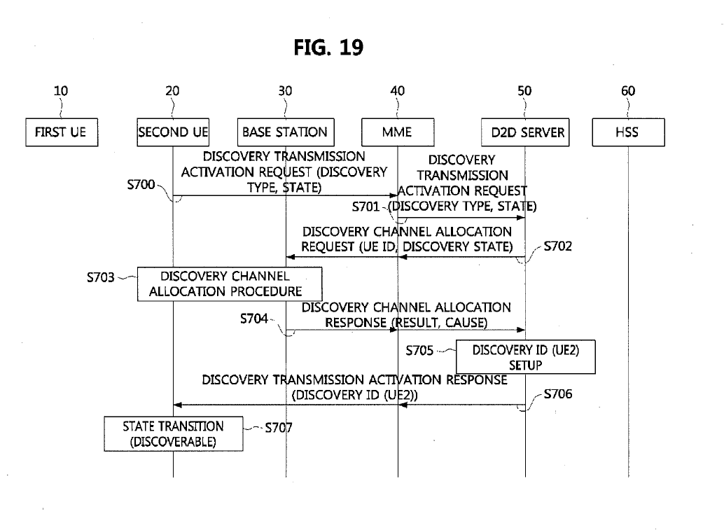

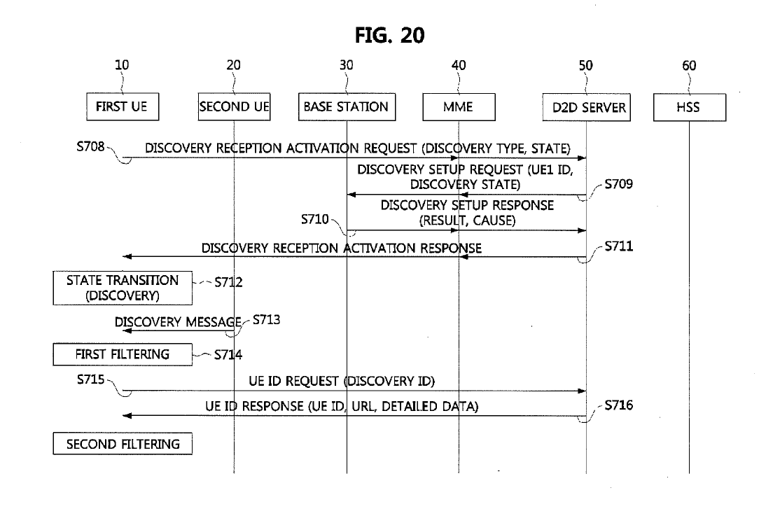

FIG. 19 is a sequence chart to depict a procedure of open-type discovery transmission activation using a control plane and a data plane, and FIG. 20 is a sequence chart to depict a procedure of discovery service using a control plane and a data plane.

In the case 3, the procedure of open-type discovery transmission activation is the same with that of the case 1, and the procedure of discovery service is the same with that of the case 2.

A configuration of information for the open-type discovery is the same with that of the case 1.

While the example embodiments of the present invention and their advantages have been described in detail, it should be understood that various changes, substitutions and alterations may be made herein without departing from the scope of the invention.

What is claimed is:

1. A method of device-to-device discovery performed in a terminal, comprising:
registering a discovery service of the terminal using service information on a service provided by an user;
transmitting a discovery transmission activation request to a network in which the terminal is located;
receiving a response in response to the discovery transmission activation request from the network; and
transmitting a discovery message when the response is an approval message.

2. The method of claim 1, wherein the service information includes information on an URL of a server which provides information on service category and detail information on the service provided.

3. The method of claim 2, wherein the information on a service category is registered using a service code which corresponds to the service category based on a predetermined code mapping scheme.

4. The method of claim 1, wherein the discovery transmission activation request includes a discovery type, a discovery state, and a discovery range class.

5. The method of claim 1, wherein the response includes information on radio resources allocated for transmission of the discovery message.

6. The method of claim 5, wherein the discovery message is transmitted using the radio resources indicated by the response.

7. The method of claim 1, wherein the discovery message includes the service code corresponding to the service category, a discovery identifier corresponding to the terminal.

8. A method of device-to-device discovery performed in a terminal, comprising:
being inputted service information on a service desired to be provided through the terminal;
transmitting a discovery reception activation request to a network in which the terminal is located;
receiving a response in response to the discovery reception activation request from the network; and
searching a discovery message from a counterpart terminal when the response is an approval message.

9. The method of claim 8, wherein the service information includes information on a service category of the service and information on keywords of the service.

10. The method of claim 9, wherein the information on a service category is registered using a service code which corresponds to the service category based on a predetermined code mapping scheme.

11. The method of claim 8, wherein the discovery reception activation request includes a discovery type and a discovery state.

12. The method of claim 8, wherein the response includes information on radio resources allocated for reception of the discovery message.

13. The method of claim 12, wherein the discovery message is searched and received on the radio resources indicated by the response.

14. The method of claim 8, wherein the discovery message includes a service code of a service provided by the counterpart terminal and a discovery identifier corresponding to the terminal which transmitted the discovery message.

15. The method of claim 14, further includes
determining whether the service code included in the discovery message is the same with the service code indicated by the service information or not; and
requesting additional information related to the service provided by the counterpart terminal when the service code included in the discovery message is the same with the service code indicated by the information on a service.

16. The method of claim 15, wherein the additional information includes an identifier of the counterpart terminal transmitting the discovery message and an address of a server providing detail information related to the service provided by the counterpart terminal.
